(19) United States
(12) Patent Application Publication
(10) Pub. No.: US 2023/0068540 A1
(43) Pub. Date: Mar. 2, 2023

(54) AIRFLOW SYSTEMS AND METHODS FOR A GENERATOR

(71) Applicant: Illinois Tool Works Inc., Glenview, IL (US)

(72) Inventor: Daniel J. Tauchen, Bonduel, WI (US)

(21) Appl. No.: 17/897,292

(22) Filed: Aug. 29, 2022

Related U.S. Application Data
(60) Provisional application No. 63/240,021, filed on Sep. 2, 2021.

(51) Int. Cl. H02K 1/20

(52) U.S. Cl. CPC H02K 1/20

(57) ABSTRACT

Systems are disclosed for a generator housing that includes an outer channel configured to create an outer airflow current across an outer surfaces of a stator arranged within the housing. For example, the outer airflow current is designed to flow in a direction coaxial with an axis of rotation of a rotor contained within the housing.

### CROSS-REFERENCE TO RELATED APPLICATIONS

This application hereby claims priority to and the benefit of U.S. Provisional Application Ser. No. 63/240,021, entitled “Airflow Systems And Methods For A Generator,” filed Sep. 2, 2021. The above listed U.S. application is hereby incorporated by reference in its entireties for all purposes.

### BACKGROUND

Conventionally, engine-driven power systems (e.g., employing engines, generators, air compressors, welders, etc.) are often arranged with little space between components. During operation, a significant amount of heat can be generated, within components and/or between components. Cooling extends the useful life of the components. However, due to size and other restrictions, airflow within and between components is often limited. Systems and methods to enhance cooling is therefore desirable.

### SUMMARY

Systems and methods are disclosed of a generator housing that includes an outer channel configured to create an outer airflow current across an outer surfaces of a stator arranged within the housing, substantially as illustrated by and described in connection with at least one of the figures, as set forth more completely in the claims.

### BRIEF DESCRIPTION OF THE DRAWINGS

FIG. 1 is a perspective view of an example generator that includes an outer channel, in accordance with aspects of this disclosure.

FIG. 2 is a longitudinal cross-sectional view of the example generator that includes an outer channel of FIG. 1.

FIG. 3 is a detailed of an example outer channel of FIG. 1.

FIG. 4A is a lateral cross-sectional view of the example generator that includes an outer channel of FIG. 1.

FIGS. 4B and 4C are opposing views of the lateral cross-sectional view of the example generator and outer channel of FIG. 4A.

The figures are not necessarily to scale. Where appropriate, similar or identical reference numbers are used to refer to similar or identical components.

### DETAILED DESCRIPTION

Disclosed are examples of a generator housing that includes an outer channel configured to create an outer airflow current across an outer surfaces of a stator arranged within the housing. For example, the outer airflow current is designed to flow in a direction coaxial with an axis of rotation of a rotor contained within the housing.

Engine driven generators are comprised of a rotor and stator. The rotor is coupled to the engine and driven to rotate within the stator, generating electrical current as a result. The high rate of rotation of the rotor (e.g., 3600 rotations per minute (RPM)) produces considerable heat during power generation, which can impact performance and/or output. Conventional techniques designed to cool the generator includes encasing the entirety of the stator, which may allow air to flow around some surfaces of the stator. Securing the stator on its end faces, as is done conventionally, leaves a limited, restrictive path through which air can flow between a gap around an outer diameter of the rotor and an inner diameter of the stator. However, the gap between the rotor and the stator is small, providing limited cooling through the generator.

The disclosed generator and generator housing allows air to flow around the stator even when it is encased on the end faces. For example, the disclosed generator airflow system includes a generator housing configured to secure the stator on its end faces (e.g., substantially planar surfaces perpendicular to the axis of rotation of the rotor), while providing an outer channel to provide an airflow current at an outer surface of the stator. For instance, the airflow current can flow through the outer channel in a direction coaxially oriented with the axis of rotation of the rotor.

In some examples, the generator housing includes an endbell casing (or first casing) with a first outer channel. An engine casing (or second casing) with a second outer channel aligns with the first outer channel. In some examples, the first and second outer channels are directly coupled to make a substantially air tight channel through which air flows. In some examples, a channel baffle is included, the channel baffle being configured to couple the first and second outer channels, thereby enclosing the outer channel between the endbell casing and the engine casing. The channel baffle can include one or more baffle mounting features (e.g., a snap-fit joint or fastener, a hook, a stud, a press-fit joint, or a fastener, etc.) to secure the channel baffle to the endbell casing and the engine casing.

In examples, a stator encased within a stator lamination stack is arranged between the endbell casing and the engine casing. The stator lamination stack may include one or more panels, with one or more of the panels is configured to receive the channel baffle or baffles, secured by the baffle mounting features. In this arrangement, the channel baffle aligns with the stator lamination stack (at the panel) that is enclosed within the housing. As a result, the outer airflow channel traverses an external portion of the stator lamination stack.

Advantageously, the generators and/or generator housings (such as casings and baffles) of this disclosure provide for improved airflow in comparison to conventional generators, where casings are placed against the stator lamination stack. Further, employing a baffle makes the casing light weight and adjustable (to accommodate a variety of stator sizes). Moreover, the disclosed examples place the generator casings about the stator lamination stack in such a way that the design is simplified, has greater reliability over conventional designs, and allows for a more compact housing (and therefore, a smaller envelope for incorporation in a larger system or enclosure). Thus, the disclosed generator housing provides a compact, cost effective, and reliable configuration, providing additional cooling, resulting in enhanced product operation and extended useful life.

In disclosed examples, an airflow system for a generator includes a generator housing with one or more outer channels, the outer channels being configured to create an outer airflow current across one or more outer surfaces of a stator arranged within the housing, the outer airflow current flowing in a direction coaxial with an axis of rotation of a rotor within the housing.

In some examples, an endbell casing comprising a first outer channel of the one or more outer channels. In examples, an engine casing comprising a second outer channel of the one or more outer channels. In examples, the first outer channel is coupled to the second outer channel creating a continuous outer channel between the endbell casing and the engine casing.

In some examples, a channel baffle is configured to couple the first outer channel to the second outer channel, the channel baffle enclosing the outer channel between the endbell casing and the engine casing. In examples, a stator lamination stack comprising one or external more panels, wherein a first panel of the one or more panels is configured to receive a bypass baffle.

In some disclosed examples, a generator housing includes an endbell casing with a first outer channel. An engine casing has a second outer channel. And a channel baffle is configured to couple the first outer channel of the endbell casing to the second outer channel of the engine casing, the channel baffle enclosing an outer channel between the endbell casing and the engine casing.

In some examples, the channel baffle includes one or more baffle mounting features to secure the channel baffle to the endbell casing and the engine casing.

In examples, the channel baffle is aligned with a stator lamination stack housed within the enclosure, the outer channel to traverse an external portion of the stator lamination stack.

In some examples, the channel baffle includes one or more baffle mounting features to secure the channel baffle to the stator lamination stack. In examples, the one or more baffle mounting features comprises one or more of a snap-fit joint or fastener, a hook, a stud, a press-fit joint, or a fastener.

In examples, the channel baffle is constructed of a material including one or more of a metal or a plastic. In examples, the generator is configured to be driven by an engine. In some examples, the generator is configured to provide an electrical output to a welder.

In some disclosed examples, a channel baffle for a generator housing includes a first end and a second end, the first end connected to an endbell casing comprising a first outer channel, and the second end connected to an engine casing comprising a second outer channel to complete an outer channel, wherein the channel baffle is configured to couple the first outer channel of the endbell casing to the second outer channel of the engine casing, the channel baffle enclosing the outer channel between the endbell casing and the engine casing.

In some examples, the channel baffle further includes one or more baffle mounting features to secure the channel baffle to the endbell casing and the engine casing.

In some examples, the channel baffle is aligned with a stator lamination stack housed within the generator housing, the outer channel to traverse an external portion of the stator lamination stack.

In some examples, the channel baffle includes one or more baffle mounting features to secure the channel baffle to the stator lamination stack.

In some examples, the one or more baffle mounting features comprises one or more of a snap-fit joint or fastener, a hook, a stud, a press-fit joint, or a fastener.

In some examples, the channel baffle is constructed of a material including one or more of a metal or a plastic.

When introducing elements of various embodiments described below, the articles “a,” “an,” and “the” are intended to mean that there are one or more of the elements. The terms “comprising,” “including,” and “having” are intended to be inclusive and mean that there may be additional elements other than the listed elements. Moreover, while the term “exemplary” may be used herein in connection to certain examples of aspects or embodiments of the presently disclosed subject matter, it will be appreciated that these examples are illustrative in nature and that the term “exemplary” is not used herein to denote any preference or requirement with respect to a disclosed aspect or embodiment. Additionally, it should be understood that references to “one embodiment,” “an embodiment,” “some embodiments,” and the like are not intended to be interpreted as excluding the existence of additional embodiments that also incorporate the disclosed features.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

As used herein, power conversion circuitry refers to circuitry and/or electrical components that convert electrical power from one or more first forms (e.g., power output by a generator) to one or more second forms having any combination of voltage, current, frequency, and/or response characteristics. The power conversion circuitry may include safety circuitry, output selection circuitry, measurement and/or control circuitry, and/or any other circuits to provide appropriate features.

As used herein, relative terms are used to aid in the reader's understanding of the various features, their configuration, and/or relative arrangement thereof. The terms “first” and “second” may be used to enumerate different components or elements of the same type, and do not necessarily imply any particular order. For example, while in some examples a first compartment is located prior to a second compartment in an airflow path, the terms “first compartment” and “second compartment” do not imply any specific order in which air flows through the compartments. Any feature can be considered a top/bottom/front/rear/first side/second side, depending on a particular arrangement, configuration, and/or perspective of the viewer.

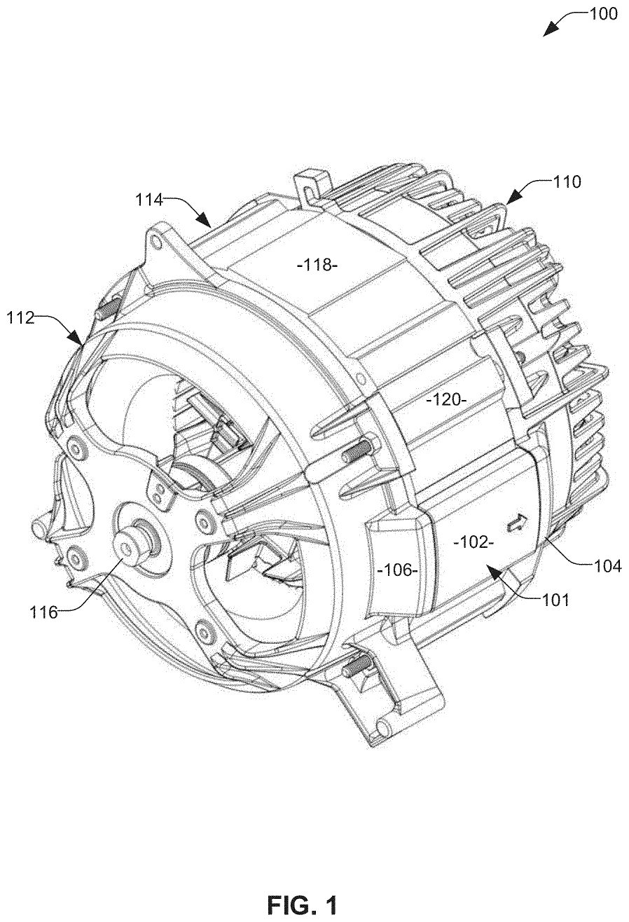

FIG. 1 is a perspective view of an example generator 100 configured to be driven by an engine (e.g., within a power system). For example, the generator 100 is configured to generate electrical power and provide it to one or more auxiliary circuits and/or devices, such as power conversion circuitry, a welder, as well as other components not specifically discussed herein.

In some examples, the generator 100 has a housing that includes an endbell casing 112 with a first outer channel 106. An engine casing 110 with a second outer channel 104 aligns with the first outer channel 106. In some examples, the first and second outer channels are directly coupled (e.g., are configured to extend across a stator or stator lamination stack 114), to make an outer channel 101 through which air flows. In some examples, a channel baffle 102 is included, the channel baffle 102 being configured to couple the first and second outer channels 104, 106, thereby enclosing the outer channel 101 between the endbell casing 112 and the engine casing 110. The stator lamination stack 114 may include one or more casing bolt channels 120 to secure the endbell casing 112 and the engine casing 110.

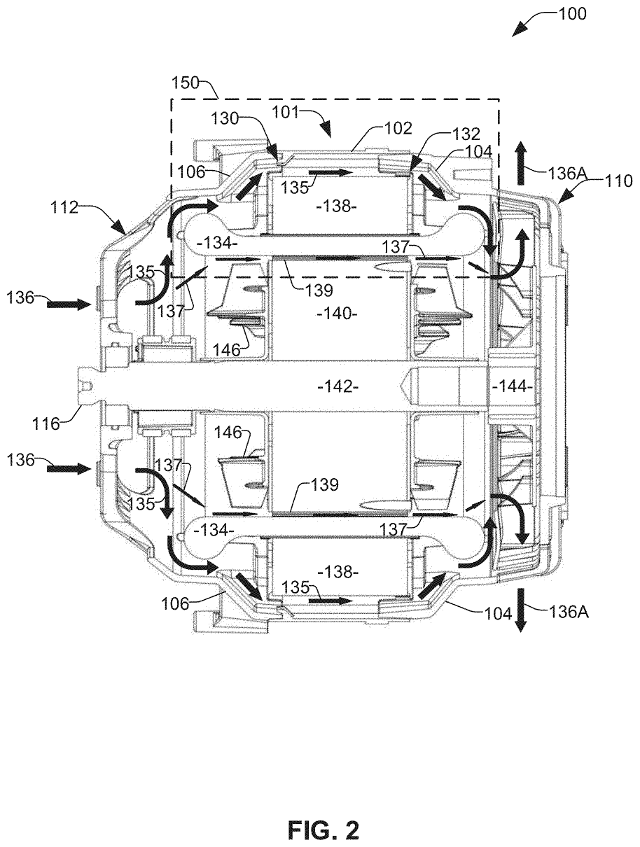

FIG. 2 is a longitudinal cross-sectional view of the example generator 100 that includes the outer channel 101. As shown, the generator 100 includes a rotor 140 arranged about a rotor shaft 142. The rotor shaft 142 is configured to be coupled to an engine transmission via a drive connection 144 (e.g., a bore at or within the rotor shaft 142 opposite an end of the rotor shaft 116), which provides mechanical power to drive the rotor 140 relative to the stator 138. One or more fans or blades 146 may be mounted to or otherwise configured to turn with rotation of the rotor shaft 142 and/or the rotor 140. One or more of these components can be entirely or partially enclosed within a housing defined by the endbell casing 112, the stator lamination stack 114, and the engine casing 110.

Movement of the rotor 140 and/or the fan 146 draws in air 136 into the interior of the housing. The air 136 can flow through one or more pathways internal to the generator 100. For example, a central airflow current 137 is drawn through a gap 139 between windings 134 and the rotor 140, whereas an outer airflow current 135 is drawn through the outer channel 101. As shown, the outer channel 101 is defined by dimensions between components (e.g., the stator 138 and the channels 104, 106 and the baffle 102) that provide a space greater than the gap 139. As a result, the volume of outer airflow current 135 is greater than the volume of central airflow current 137. In some examples, the space created in the outer channel 101 is designed to draw in air to increase cooling of the stator 138, but not so great as to divert all airflow away from the gap 139. In some examples, the incoming air 136 flows in a direction from the endbell casing 112, over the stator 138, and out the engine casing 110, exhausting heated air 136A. In some examples, the airflow can enter and exit the housing at any number of locations, openings, gratings, etc. As shown, the two airflow currents 135 and 137 combine at they are exhausted from the housing, while in some examples exhausted air 136A may exit the housing at any number of locations, openings, gratings, etc.

An example generator operating with a maximum auxiliary power (e.g., approximately 10.5 kilowatts) in an environment with an elevated, yet controlled, temperature (e.g., 40° C.) for a given period of time (e.g., 2 hours), employing the airflow bypass baffle system disclosed herein would experience a notable decrease in temperature.

For instance, a generator operating without the disclosed airflow bypass baffle (e.g., a conventional generator housing) would have elevated rotor winding temperatures and stator winding temperatures relative to a generator operating with the disclosed airflow bypass baffle (e.g., experimentally in the range of 7% to 20%, or on the order of approximately 10%). Measured rotor winding temperature for a conventional generator may be approximately 171° C., and stator winding temperatures may be approximately 138° C.

By contrast, generators employing the disclosed airflow bypass baffle measured rotor winding temperatures of approximately 158° C. and stator winding temperatures of approximately 125° C. in similar conditions. Advantageously, the cooler winding temperatures of the generator employing the airflow bypass baffle was capable of higher output due to the decreased operating temperatures.

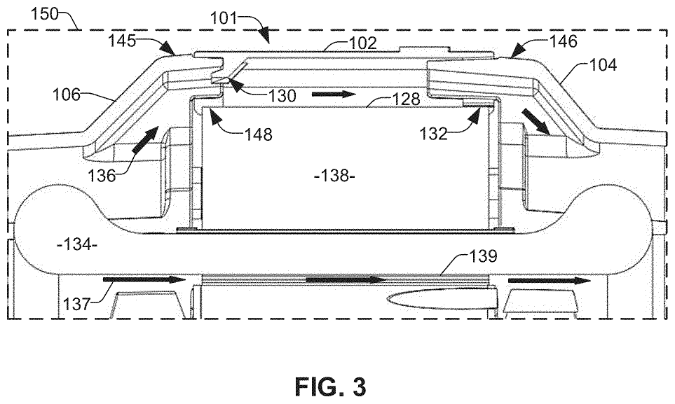

The baffle 102 is configured to enhance/enclose airflow through the outer channel 101, and serve as a connector between the outer channels 104 and 106. As shown in area 150 (with a detailed view provided in FIG. 3), the baffle 102 may include one or more baffle mounting features for arranging and/or securing the baffle 102 to the casings and/or the stator (e.g., the stator lamination stack 114). For example, the baffle 102 may include one or more baffle casing hook devices 130 (e.g., a snap-fit joint or fastener, a hook, a stud, a press-fit joint, a fastener, etc.) to secure the baffle 102 to an endbell casing interface 145 and/or an engine casing interface 146 of the outer channels 104 and 106. The baffle 102 may further include one or more baffle stator hook devices 132, 148 (e.g., a snap-fit joint or fastener, a hook, a stud, a press-fit joint, a fastener, etc.) to secure the baffle to the stator 138 and/or the stator lamination stack 114.

In additional or alternative examples, the casings 104, 106 and/or the stator 138 may include one or more mounting features to receive the baffle 102. For instance, such mounting features may mate with and/or otherwise complement the baffle mounting features to secure the baffle 102 to the generator 100.

As shown, the engine casing interface 146 extends over an outer surface 128 of the stator 138 a distance greater than the endbell casing interface 145. This offset makes inserting the baffle 102 into the housing (e.g., once the endbell casing 112 and engine casing 110 are secured to the stator lamination stack 114/stator 138). In other words, the arrangement of extending interfaces allows for the baffle 102 to be “snapped” into place employing the mounting features (such as baffle casing hook device 130), while substantially closing gaps between casings and between the casings and the stator.

In some examples, one or more of the endbell casing interface 145, the engine casing interface 146, and/or other extension features of the endbell casing and/or the engine casing may be configured to extend across the stator 138 and mate with an opposing casing interface. For example, the casings can be configured to extend over the stator and make contact between the outer channels 104 and 106 without employing a baffle. This can be achieved even as the casings are secured to opposite faces of the stator, with an interface and/or extension designed to extend beyond a plane corresponding to the relative face of the stator upon which the casing is mounted. Therefore, an outer channel for enhance airflow can be achieved without the use of a baffle.

In some examples, the baffle 102 is configured to provide a lightweight, low-cost connection between the outer channels 104 and 106. For instance, one or more characteristics of the baffle 102 (e.g., a length, width, shape, etc.) can be modified to accommodate a variety of enclosure types. Therefore, characteristics of the baffle can be changed to fit an opening (e.g., one or more stator lamination stack panels 118) based on changes to casing sizes and/or a distance between casings (e.g., due to changes in stator size). As a result, housing sizes and arrangements can be changed, while modifications to the low-cost baffle (which are easily implemented) ensure the outer channel remains.

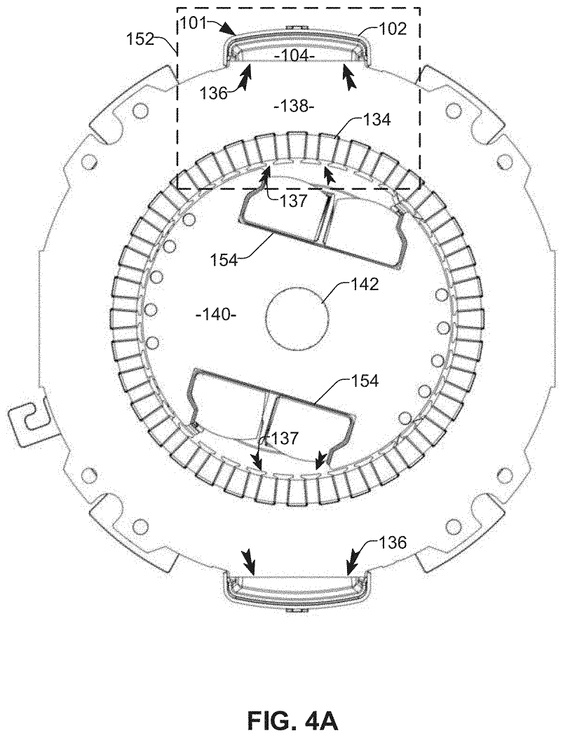

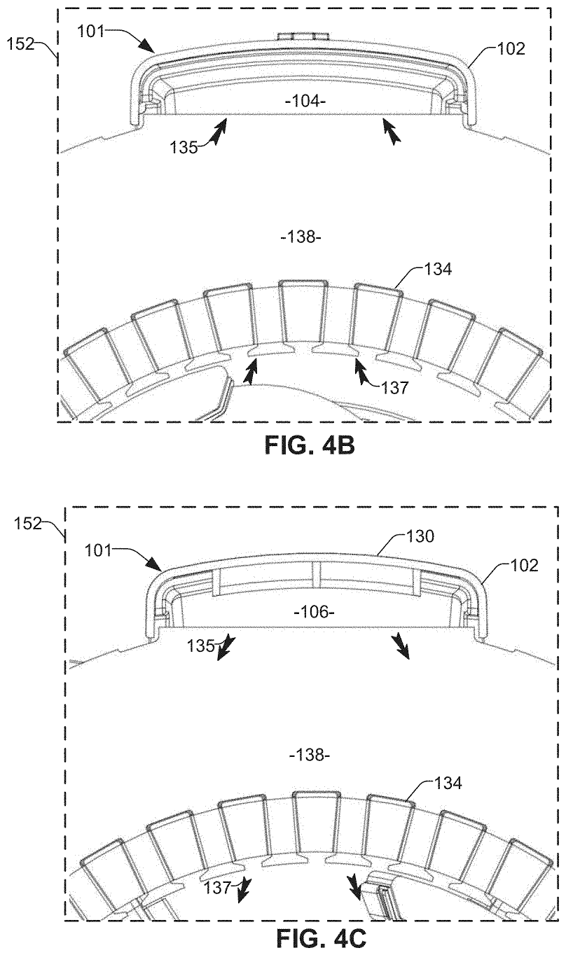

FIG. 4A illustrates a lateral cross-sectional view of the generator 100 and outer channel 101 (e.g., along a plane through the center of the stator lamination stack 114). As shown, the baffle 102 is connected to the second outer channel 104, as airflow current 135 (as well as airflow current 137) is directed into the engine casing 110 (e.g., from the endbell casing 112). FIGS. 4B and 4C illustrate opposing views of detail 152 of the outer channel 101 shown in FIG. 4A. In particular, FIG. 4B provides the view of the outer channel 101 into the second outer channel 104 from the endbell casing 112 (similar to FIG. 4A). FIG. 4C provides the opposing view into the first outer channel 106 of the endbell casing 112 from the engine casing 110, with airflow currents 135 and 137 flowing out of the endbell casing 112.

In some examples, the baffle 102 comprises a lightweight material (e.g., a polymer such as polypropylene, a composite material, a lightweight metal, etc.), providing a degree of heat resistance, while making the housing/casing lighter than one employing all-metallic components.

In some examples, the casings or housing is formed of a substantially rigid material (e.g., a metal castings), which provides structural integrity for the generator, environmental protection for the equipment, and provides a safety, sound, and aesthetic barrier for the operators. The size and serviceability of the generator, how compact the unit is, relative ease of assembling the generator and channeling system, as well as costs and durability, are directly related to the configuration of enclosure, its components and in how they interact.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. An airflow system for a generator comprising a generator housing comprising one or more outer channels, the outer channels configured to create an outer airflow current across one or more outer surfaces of a stator arranged within the housing, the outer airflow current flowing in a direction coaxial with an axis of rotation of a rotor within the housing.

2. The airflow system as defined in claim 1, further comprising an endbell casing comprising a first outer channel of the one or more outer channels.

3. The airflow bypass system as defined in claim 2, further comprising an engine casing comprising a second outer channel of the one or more outer channels.

4. The airflow bypass system as defined in claim 3, wherein the first outer channel is coupled to the second outer channel creating a continuous outer channel between the endbell casing and the engine casing.

5. The airflow bypass system as defined in claim 3, further comprising a channel baffle configured to couple the first outer channel to the second outer channel, the channel baffle enclosing the outer channel between the endbell casing and the engine casing.

6. The airflow bypass system as defined in claim 1, further comprising a stator lamination stack comprising one or external more panels, wherein a first panel of the one or more panels is configured to receive a bypass baffle.

7. A generator housing comprising:
an endbell casing comprising a first outer channel; and
an engine casing comprising a second outer channel; and
a channel baffle configured to couple the first outer channel of the endbell casing to the second outer channel of the engine casing, the channel baffle enclosing an outer channel between the endbell casing and the engine casing.

8. The generator housing as defined in claim 7, wherein the channel baffle comprises one or more baffle mounting features to secure the channel baffle to the endbell casing and the engine casing.

9. The generator housing as defined in claim 7, wherein the channel baffle is aligned with a stator lamination stack housed within the enclosure, the outer channel to traverse an external portion of the stator lamination stack.

10. The generator housing as defined in claim 7, wherein the channel baffle comprises one or more baffle mounting features to secure the channel baffle to the stator lamination stack.

11. The generator housing as defined in claim 10, wherein the one or more baffle mounting features comprises one or more of a snap-fit joint or fastener, a hook, a stud, a press-fit joint, or a fastener.

12. The generator housing as defined in claim 7, wherein the channel baffle is constructed of a material including one or more of a metal or a plastic.

13. The generator housing as defined in claim 7, wherein the generator is configured to be driven by an engine.

14. The generator housing as defined in claim 7, wherein the generator is configured to provide an electrical output to a welder.

15. A channel baffle for a generator housing, the channel baffle comprising a first end and a second end, the first end connected to an endbell casing comprising a first outer channel, and the second end connected to an engine casing comprising a second outer channel to complete an outer channel,
wherein the channel baffle is configured to couple the first outer channel of the endbell casing to the second outer channel of the engine casing, the channel baffle enclosing the outer channel between the endbell casing and the engine casing.

16. The channel baffle as defined in claim 15, further comprising one or more baffle mounting features to secure the channel baffle to the endbell casing and the engine casing.

17. The channel baffle as defined in claim 15, wherein the channel baffle is aligned with a stator lamination stack housed within the generator housing, the outer channel to traverse an external portion of the stator lamination stack.

18. The channel baffle as defined in claim 15, wherein the channel baffle comprises one or more baffle mounting features to secure the channel baffle to the stator lamination stack.

19. The channel baffle as defined in claim 18, wherein the one or more baffle mounting features comprises one or more of a snap-fit joint or fastener, a hook, a stud, a press-fit joint, or a fastener.

20. The channel baffle as defined in claim 15, wherein the channel baffle is constructed of a material including one or more of a metal or a plastic.
